(19) United States
(12) Patent Application Publication
(10) Pub. No.: US 2006/0054843 A1
(43) Pub. Date: Mar. 16, 2006

(54) Method and apparatus of improving optical reflection images of a laser on a changing surface location

(75) Inventors: Jeffrey A. Simpson, Wayne, NE (US); Mark A. Imbrock, Sylvania, OH (US)

Correspondence Address: MACMILLAN SOBANSKI & TODD, LLC;ONE MARITIME PLAZA FOURTH FLOOR, 720 WATER STREET, TOLEDO, OH, 43604-1619, US

(73) Assignee: Electronic Design To Market, Inc., Wayne, NE (US)

(21) Appl. No.: 11/225,477

(22) Filed: Sep. 13, 2005

Related U.S. Application Data
(60) Provisional application No. 60/609,382, filed on Sep. 13, 2004.

(51) Int. Cl. G01N 21/86

(52) U.S. Cl. 250/559.27

(57) ABSTRACT

A method and apparatus for optically measuring properties of sheets of transparent material which may be moving. The apparatus includes a non-Gaussian line laser beam generator and a linear sensor such as a CCD array which senses the spacing of reflections of the laser beam from surfaces of the material and the strength of the reflections. The width of the line laser beam extends in a direction perpendicular to the direction of the linear sensor. The line laser beam is directed at an angle to the surfaces of the material and surface reflections detected by the sensor are used to detect at least one property of the material, such as surface spacings or the presence and location of a surface coating. The line laser beam reflections will strike the sensor even when the material is not precisely parallel to the sensor.

### CROSS-REFERENCE TO RELATED APPLICATIONS

Applicants claim priority to U.S. Provisional Patent Application Ser. No. 60/609,382 filed Sep. 13, 2004.

### STATEMENT REGARDING FEDERALLY SPONSORED RESEARCH OR DEVELOPMENT

Not Applicable.

### TECHNICAL FIELD

A method of obtaining improved thickness measurements and/or of the identification of the presence and location of surface coatings of transparent materials that may be moving during the measurement process.

### BACKGROUND OF THE INVENTION

In the coating and glass industry, for example, there are applications where properties of a transparent medium must be measures. For example, it may be necessary to inspect glass during the manufacturing of windows to confirm the glass or air space thickness, or to identify coated surfaces such as LOW-E energy efficient coatings that have been applied to the glass. The window industry has used hand held laser devices that measure the glass thickness by being directly placed on the glass itself. These devices use a standard laser with a round dot image reflected from surfaces of the glass under test which is stationary. Prior art devices, as shown for example in U.S. Pat. No. 6,683,695, use a laser to measure the location of the coating. These devices do not allow for the medium under test to change its relative location from the laser or sensor while conducting measurements. Movement of the material can cause the reflected laser sensing beam to move during the testing process. This movement can produce a poor quality signal which can lead to inaccurate measurements or to the total failure to obtain a measurement.

### BRIEF SUMMARY OF THE INVENTION

The invention related to a method for improving the signal quality of the reflected laser beam, especially from a moving transparent material. The sensor is mounted, for example, between the rollers of a glass movement system for washing, etc. The sensor uses a line beam generated by the optics of a laser. Preferably, the beam is a non-Gaussian type laser beam. Generally as a piece of glass or other transparent material is loaded onto a roller system, the glass does not initially lay totally parallel to the surface of the sensor that senses surface reflections of the laser beam. This unparallel situation can be caused by a variety of conditions, including: 1) as operator places the glass onto the conveyor at a point where the glass is positioned over the sensor, the sensor begins conducting a measurement before the glass has been released by the operator onto the conveyor, or 2) the conveyor rollers may be uneven and the glass rocks as it passes from conveyor roller to roller. The reflected image created by a dot type laser will often miss a CCD array line sensor until the glass is close to the laser or mounted at a known angle to guarantee that the laser beam will be reflected back to the sensor. If a round dot-generating laser is used with a shutter at the aperture to physically block a portion of the lasers energy, (effectively creating a line image from the laser), significant amounts of laser energy is unused. Further, the energy level can vary significantly along the length of the beam. The shutter opening may often be extremely small, since the sensing elements of a CCD array can often have 1000 or more sensing elements in 1 inch (2.54 cm) length.

The laser beams usefulness improves from being a non-Gaussian type of laser beam. Typical manufactured lasers follow a Gaussian pattern of laser beam power wherein the center of the laser beam has the greatest intensity of power and the laser beam intensity then falls off at increasing distance away from the center of the laser beam. A non-Gaussian laser beam generally keeps substantially the same relative amount of laser energy level over the majority of the length of an optically generated laser line image. The intensity level will drop off only at the ends of the line beam. When the laser beam is reflected from the moving subject under test, the amount of reflected energy striking a line sensor is about the same, regardless of the slight variation in angle of the material being tested relative to the sensor.

The thickness of the laser beam needs to be as small as possible. A 50 um thickness beam, for example, on a line based CCD array with 1000 or more elements per inch allows measurements of reflections from multiple surfaces of a transparent medium with highly reflective qualities to occur without saturating each individual CCD pixel element, which could result in a cascaded sharing or bleed over effect of energy with successive elements. This is critical in thickness measurements where individual successive peaks from each surface could bleed together into a single peak.

The invention also is applicable when the glass or other transparent medium under test is moving in a direction other than horizontal, such as vertical.

Various objects and advantages of the invention will become apparent from the following detailed description of the invention and the accompanying drawings.

### BRIEF DESCRIPTION OF THE DRAWINGS

FIG. 1 is a diagrammatic side elevational view showing a sheet of glass positioned to rest on supporting rollers with a laser unit according to the invention positioned below the glass sheet between two rollers to direct a non-Gaussian line beam at an angle to the glass surfaces;

FIG. 2 is a diagrammatic side elevational view showing a laser beam generator directing a beam at an angle to surfaces of a sheet of glass with surface reflections of the beam impinging on a CCD array line sensor;

FIG. 3 is a diagrammatic view showing details of a point laser beam laser unit and a projection of this laser beam as used in prior art sensors;

FIG. 4 is a diagrammatic view showing an enlarged projection of a point laser beam and the energy distribution across the point laser beam;

FIG. 5 is a plan view showing a prior art point laser beam reflection missing the CCD array line sensor due to misalignment of the glass surface with the sensor;

FIG. 6 is a diagrammatic view showing a line laser beam laser unit as used in the sensor of the present invention and a projection of a line laser beam;

FIG. 7 is a diagrammatic view showing an enlarged projection of the line laser beam and the energy distribution across a non-Gaussian line laser beam;

FIG. 8 is a plan view showing a line laser beam reflection impinging on the CCD array line sensor when the reflective surfaces are parallel to the sensor;

FIG. 9 is a plan view showing a line laser beam reflection angled relative to the CCD array line sensor due to misalignment of the glass surface with the sensor, but with the reflections still impinging on the sensor;

FIG. 10 is a plan view showing a line laser beam reflection in a direction angled opposite to FIG. 9 relative to the CCD array line sensor due to misalignment of the glass surface with the sensor, but with the reflections still impinging on the sensor;

FIG. 11 is a graph showing glass surface reflections from a thin relatively wide non-Gaussian line laser beam which allows individual images for reflections from each surface to be seen by the CCD array line sensor; and

FIG. 12 is a graph showing the two images of FIG. 11 bleeding together as a consequence of using a wider line or point laser beam.

### DETAILED DESCRIPTION OF THE INVENTION

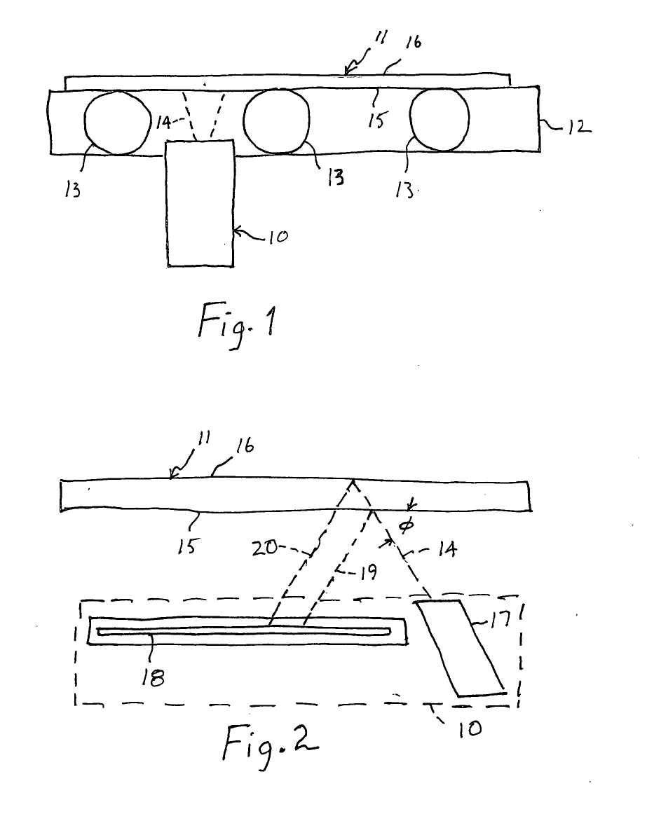

Referring to FIGS. 1 and 2 of the drawings, apparatus 10 is shown according to the invention for measuring the thickness of a sheet or transparent material such as glass 11 while the glass 11 is moving on a conveyor 12 which includes spaced rollers 13. The apparatus 10 directs a non-Gaussian, line generated laser beam 14 at an angle to lower and upper surfaces 15 and 16 of the glass 11. The apparatus 10 includes a laser 17 and a sensor 18 which is preferably a CCD array line sensor. The sensor is positioned to be impinged by reflections 19 and 20 from the glass surfaces 15 and 16, respectively. Based on the impingement angle ø of the laser beam 14 to the glass surfaces 15 and 16, the thickness of the glass 11, or the thickness of each sheet of glass and the spacings between the sheets of glass in an insulated glass composite are determined from the spacings of the surface reflections measured at the sensor 18.

For insulated windows, the single sheet of glass 11 shown in FIGS. 1 and 2 may be a composite of two or more spaced sheets of glass. The CCD array line sensor 18 is of sufficient length to receive and sense the location of each surface reflection. If none of the glass surfaces is coated, the reflections sensed by the CCD array line sensor 18 will have substantially the same energy level. If a surface is coated, for example, with a LOW-E low energy coating, the reflection from the coated surface will have a greater intensity than uncoated surface reflections since more of the energy striking the coated surface will be reflected.

In FIG. 1, the apparatus 10 is shown mounted between two rollers 13 supporting the glass 11 in a production environment. However, the apparatus 10 may be mounted above the glass 11 or next to glass located or moving in a direction other than horizontal. It should be appreciated that the material under test may be any transparent material, such as a transparent plastic material, in addition to the disclosed glass 11.

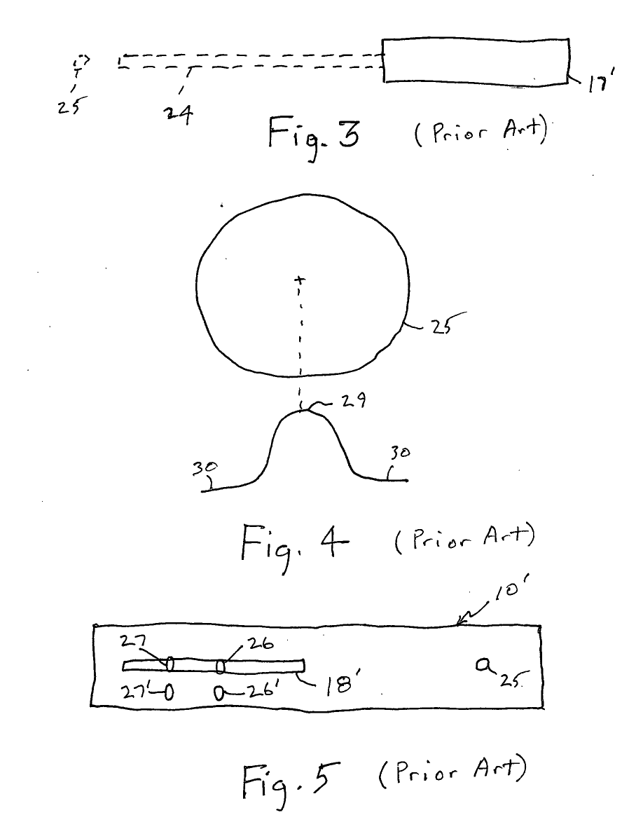

FIGS. 3-5 show a typical point laser 17′ used in prior art apparatus 10′ for measuring properties of glass and other transparent materials. The laser 17′ produces a round beam 24 which in projection appears as a point or dot 25 when in impinges on a surface. As best illustrated in FIG. 5, the laser 17′ is aligned with a CCD array line sensor 18′. So long as the sensor 18′ is maintained parallel to the surfaces being tested, surface reflections 26 and 27 of the round laser beam 24 will impinge on the CCD array line sensor 18′. However, if the moving glass becomes out of parallel with the sensor 18′, the reflections 26′ and 27′ will miss the CCD array line sensor 18′.

FIG. 4 shows a typical Gaussian energy distribution 28 across a diameter of the generally round reflection of the light reflection 26. It will be appreciated that the reflection 26 may be slightly distorted out of round when the beam 14′ is reflected by the glass or other transparent material. It will be seen that the energy peaks at 29 in the center area of the beam and is significantly lower at 30 moving towards outer edges of the beam. As a consequence, even a minor misalignment between the sensor 18′ and the glass can cause the sensor 18′ to receive lower energy levels in the laser beam reflections 26 and 27.

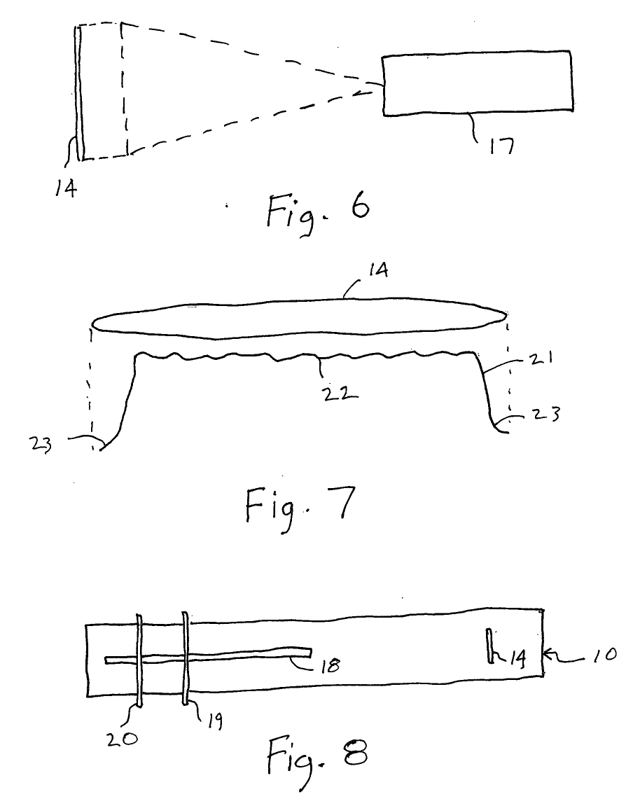

FIGS. 6 and 7 show details of the laser beam 14 having a non-Gaussian power distribution curve 21. The non-Gaussian laser allows uniform reflected power readings to occur from various positions on the elongated or line laser beam 14. Preferably, the line laser beam 14 is produced using an optical focusing lens rather than using shutters to block edges of the laser aperture. The thickness of the laser beam 14 may be adjustable or fixed. Preferably, the thickness of the 14 is as small as possible. As shown in the energy power distribution curve 21 in FIG. 7, the energy power distribution is substantially constant at 22 over the majority of the width of the line beam 14, dropping off only at 23 adjacent ends of the line beam 14.

A 50 um thickness beam impinging on a line based CCD array with as many as 1000 or more elements per inch allows measurements of reflections from multiple surfaces of a transparent medium to occur without saturating each individual CCD array element, which could result in a cascaded sharing of energy with successive elements. This is critical in thickness measurements where individual successive peaks from each surface could bleed together into a single peak, especially when measuring the thickness of a thin sheet of transparent material.

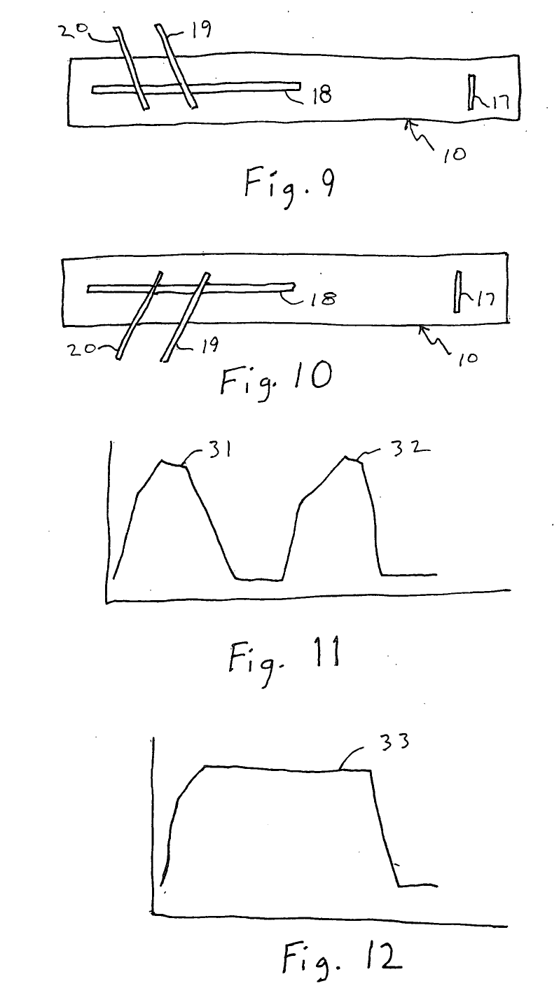

As shown in FIG. 8, the laser beam 14 extends along a line which is perpendicular to the elongated sensor 18. When the glass 111 or other material under test is parallel to the sensor 18, the centers of the line laser beam reflections 19 and 20 will impinge on the sensor 18. FIGS. 9 and 10 show the reflections 19 and 20 when the glass 11 is moved in opposite directions slightly out of parallel with the sensor 18. In either case, the reflections 19 and 20 continue to impinge on the sensor 18 and accurate readings may be made. Further, the amount of energy striking the sensor 18 will continue to be substantially constant, unlike laser beams having a Gaussian energy distribution.

As the glass 11 under test is released by the operator onto the roller system and travels along the conveyor 12, the reflected amount of laser power that impinges upon a small point of the sensor 18 will be approximately the same, despite small variations in the angle of the glass to the sensor 18. The use of a line-generating laser 17 allows for limited angular movement of the glass 11 relative to the sensor 18, since a line at angles other than parallel to the CCD array sensor effectively touches only a small amount of the sensing elements. The glass may be moved during the measurement because the length of the (non-Gaussian) laser-line image that is reflected onto the CCD array line sensor 18 will guarantee that the signal hits the sensor 18. The spacing between the reflections 19 and 20 is dependent on the spacing between the glass surfaces 15 and 16. This spacing will remain substantially constant even when the glass is at a slight angle out of parallel with the sensor 18. The amount of laser power received by the sensor 18 also will be substantially unchanged since it does not matter if the received energy is from the center or off center towards an end of the reflected line beam. Measurements that are based upon an absolute value of energy being measured will now be accurate, while a point-generating, Gaussian laser would lead to possible incorrect measurements.

A thin laser beam allows greater resolution of thinner materials under test and allows surfaces to be coated with more reflective substances before the surface reflections bleed together on the CCD array. FIG. 11 shows the separate measured energy peaks 31 and 32 produced by a thin line laser beam, while FIG. 12 shows a single merged peak 33 from two reflections from a wider line or point laser beam.

The apparatus 10 processes information from the CCD array sensor 18 in a known manner to determine physical attributes of the material under test, such as the thickness of sheets of glass and/or the surface location of a transparent surface coating. Apparatus 10 according to the invention improves the signal quality of reflected laser beams from surfaces of transparent material to provide more accurate information. A non-Gaussian laser allows uniform reflected power readings to occur from various positions on the laser beam.

In addition to the physical attributes of the non-Gaussian laser and the thickness of the laser beam, software can also be used to protect from the conditions described above. As the glass is being placed onto the line or is rocking irregularly, the location of the reflected laser image onto the CCD array sensor can be monitored to know when the glass being tested has been released onto the line and when it is laying in its “resting” position on the conveyor. The electronics can be programmed so that the first-surface laser reflection should fall into a narrow specified location on the CCD array sensing elements. This narrow location can indicate when the glass surfaces are parallel to the CCD array sensor. Software also can monitor this situation and provide a safety buffer to prevent the sensor from taking measurements prior to the glass being released onto the conveyor.

It will be appreciated that various modifications and changes may be made to the above described preferred embodiment of without departing from the scope of the following claims.

1. Apparatus for testing a property of a sheet of transparent material comprising a line laser which mounted to direct a laser beam at an angle to a surface of a sheet of transparent material to be tested, said laser beam having a width and a thickness substantially smaller than its width, an elongated sensor mounted to sense the locations of spaced reflections of the laser beam from surfaces of a sheet of transparent material to be tested, said elongated sensor extending in a predetermined direction, and wherein the width of said laser beam extends in a direction perpendicular to said predetermined direction.

2. Apparatus for testing a property of a sheet of transparent material, as set forth in claim 1, and wherein said line laser produces a non-Gaussian laser beam having a substantially uniform energy level along a majority of the width of the laser beam.

3. Apparatus for testing a property of a sheet of transparent material, as set forth in claim 2, and wherein said elongated sensor detects the locations of reflections of the laser beam from multiple surfaces of spaced sheets of transparent material.

4. Apparatus for testing a property of a sheet of transparent material, as set forth in claim 2, and wherein said elongated sensor further detects the strengths of each surface reflection.

5. Apparatus for testing a property of a sheet of transparent material, as set forth in claim 4, wherein said elongated sensor is a CCD array.

6. Apparatus for testing a property of a sheet of transparent material, as set forth in claim 1, and wherein a center of the width of the laser beam is in a plane extending along said predetermined direction.

7. A method for testing a property of a sheet of transparent material comprising the steps of
a) providing an elongated sensor which extends in a predetermined direction;
b) providing a generally flat light beam having a width significantly greater than a thickness positioned with a width of the light beam extending in a direction perpendicular to said predetermined direction; and
c) directing the light beam at an angle to a sheet of transparent material in a direction whereby reflections from surfaces of the transparent material impinge in the sensor.

8. A method for testing a property of a sheet of transparent material on a conveyor, as set forth in claim 7, and wherein the light beam is directed at an angle to a sheet of transparent material moving on a conveyor.

9. A method for testing a property of a sheet of transparent material, as set forth in claim 7, and wherein the generally flat light beam is provided by a non-Gaussian laser which provides a generally flat light beam having substantially uniform energy distribution over a majority of its width.
